(19) United States
(12) Patent Application Publication
(10) Pub. No.: US 2023/0107110 A1
(43) Pub. Date: Apr. 6, 2023

(54) DEPTH PROCESSING SYSTEM AND OPERATIONAL METHOD THEREOF

(71) Applicant: eYs3D Microelectronics, Co., Taipei City (TW)

(72) Inventors: Chao-Chun Lu, Taipei City (TW); Ming-Hua Lin, Taipei City (TW); Chi-Feng Lee, Hsinchu County (TW)

(73) Assignee: eYs3D Microelectronics, Co., TAIPEI CITY (TW)

(21) Appl. No.: 17/956,847

(22) Filed: Sep. 30, 2022

Related U.S. Application Data
(63) Continuation-in-part of application No. 15/949,087, filed on Apr. 10, 2018, now abandoned.
(60) Provisional application No. 62/483,472, filed on Apr. 10, 2017.
(60) Provisional application No. 62/511,317, filed on May 25, 2017.
(60) Provisional application No. 63/343,547, filed on May 19, 2022.

(51) Int. Cl. G06T 7/50; G06T 7/10; G06T 7/20

(52) U.S. Cl. CPC G06T 7/50; G06T 7/10; G06T 7/20; G06T 2207/20021

(57) ABSTRACT

A depth processing system includes a plurality of depth capturing devices and a processor. Each depth capturing device of the plurality of depth capturing devices generates depth information corresponding to a field-of-view thereof according to the field-of-view. The processor fuses a plurality of depth information generated by the plurality of depth capturing devices to generate a three-dimensional point cloud/panorama depths corresponding to a specific region, and detects a moving object within the specific region according to the three-dimensional point cloud/the panorama depths.

### CROSS REFERENCE TO RELATED APPLICATIONS

This application is a continuation-in-part of U.S. Application No. 15/949,087, filed on April 10th, 2018, which claims the benefit of U.S. Provisional Application No. 62/483,472, filed on April 10th, 2017, and claims the benefit of U.S. Provisional Application No. 62/511,317, filed on May 25th, 2017. Further, this application claims the benefit of U.S. Provisional Application No. 63/343,547, filed on May 19th, 2022. The contents of these applications are incorporated herein by reference.

### BACKGROUND OF THE INVENTION

### 1. Field of the Invention

The present invention relates to a depth processing system and an operational method thereof, and particularly to a depth processing system and an operational method thereof that can detect a moving object within a specific region and generate notification information corresponding to the moving object.

### 2. Description of the Prior Art

As the demand for all kinds of applications on electronic devices increases, deriving the depth information for the exterior objects becomes a function required by many electronic devices. For example, once the depth information of the exterior objects, that is, the information about the distances between the objects and the electronic device is obtained, the electronic device can identify objects, combine images, or implement different kinds of application according to the depth information. Binocular vision, structured light, and time of flight (ToF) are few common ways to derive depth information nowadays.

However, in prior art, since the depth processor can derive the depth information corresponding to the electronic device from one single view point, there may be blind spots and the real situations of the exterior objects cannot be known. In addition, the depth information generated by the depth processor of the electronic device can only represent its own observing result and cannot be shared with other electronic devices. That is, to derive the depth information, each of the electronic devices should need its own depth processor. Consequently, it is difficult to integrate the resources and complicated for designing the electronic devices.

### SUMMARY OF THE INVENTION

An embodiment of the present invention provides a depth processing system. The depth processing system includes a plurality of depth capturing devices and a processor. Each depth capturing device of the plurality of depth capturing devices generates depth information corresponding to a field-of-view thereof according to the field-of-view. The processor fuses a plurality of depth information generated by the plurality of depth capturing devices to generate a three-dimensional point cloud/panorama depths corresponding to a specific region, and detects a moving object within the specific region according to the three-dimensional point cloud/the panorama depths.

According to one aspect of the present invention, the processor further generates notification information corresponding to the moving object to at least one depth capturing device of the plurality of depth capturing devices, wherein a field-of-view of the at least one depth capturing device does not cover the moving object.

According to one aspect of the present invention, the each depth capturing device is a time of flight (ToF) device, the each depth capturing device includes a plurality of light sources and a sensor, and the sensor senses reflected light generated by the moving object and generates depth information corresponding to the moving object accordingly, wherein the reflected light corresponds to light emitted by the plurality of light sources.

According to one aspect of the present invention, the plurality of light sources are light emitting diodes (LEDs) or laser diodes (LDs), the light emitted by the plurality of light sources is infrared light, and the sensor is an infrared light sensor.

According to one aspect of the present invention, the sensor is a fisheye sensor, and a field-of-view of the fisheye sensor is not less than 180 degrees.

According to one aspect of the present invention, a frequency or a wavelength of the light emitted by the plurality of light sources is different from a frequency or a wavelength of light emitted by a plurality of light sources included in other depth capturing devices of the plurality of depth capturing devices.

According to one aspect of the present invention, the depth processing system further includes a structured light source, wherein the structured light source emits structured light toward the specific region, and the each depth capturing device generates the depth information corresponding to the field-of-view thereof according to the field-of-view thereof and the structured light.

According to one aspect of the present invention, the structured light source is a laser diode (LD) or a digital light processor (DLP).

According to one aspect of the present invention, the processor further stores the depth information and the three-dimensional point cloud/the panorama depths corresponding to the specific area in a voxel format.

According to one aspect of the present invention, the processor divides the specific region into a plurality of unit spaces; each unit space corresponds to a voxel; when a first unit space has points more than a predetermined number, a first voxel corresponding to the first unit space has a first bit value; and when a second unit space has points no more than the predetermined number, a second voxel corresponding to the second unit space has a second bit value.

Another embodiment of the present invention provides an operational method of a depth processing system, and the depth processing system includes a plurality of depth capturing devices and a processor. The operational method includes each depth capturing device of the plurality of depth capturing devices generating depth information corresponding to a field-of-view thereof according to the field-of-view; the processor fusing a plurality of depth information generated by the plurality of depth capturing devices to generate a three-dimensional point cloud/panorama depths corresponding to a specific region; and the processor detecting a moving object within the specific region according to the three-dimensional point cloud/the panorama depths.

According to one aspect of the present invention, the operational method further includes the processor generating notification information corresponding to the moving object to at least one depth capturing device of the plurality of depth capturing devices, wherein a field-of-view of the at least one depth capturing device does not cover the moving object.

According to one aspect of the present invention, the processor executes a synchronization function to control the plurality of depth capture devices to synchronously generate the plurality of depth information.

According to one aspect of the present invention, when the each depth capturing device is a time of flight (ToF) device, a frequency or a wavelength of light emitted by a plurality of light sources included in the each depth capturing device is different from a frequency or a wavelength of light emitted by a plurality of light sources included in other depth capturing devices of the plurality of depth capturing devices.

According to one aspect of the present invention, the depth processing system further includes a structured light source, the structured light source emits structured light toward the specific region, and the each depth capturing device generates the depth information corresponding to the field-of-view thereof according to the field-of-view thereof and the structured light.

According to one aspect of the present invention, the processor detecting the moving object within the specific region according to the three-dimensional point cloud/the panorama depths includes the processor generating a mesh according to the three-dimensional point cloud; the processor generating real-time three-dimensional environment information corresponding to the specific region according to the mesh; and the processor detecting the moving object within the specific region according to the real-time three-dimensional environment information.

According to one aspect of the present invention, the operational method further includes the processor further storing the depth information and the three-dimensional point cloud/the panorama depths corresponding to the specific area in a voxel format.

According to one aspect of the present invention, the operational method further includes the processor dividing the specific region into a plurality of unit spaces; each unit space corresponding to a voxel; a first voxel corresponding to a first unit space having a first bit value when the first unit space has points more than a predetermined number; and a second voxel corresponding to a second unit space having a second bit value when the second unit space has points no more than the predetermined number.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a depth processing system according to one embodiment of the present invention.

FIG. 2 shows the timing diagram of the first capturing times of the depth capturing devices.

FIG. 3 shows the timing diagram of the second capturing times for capturing the pieces of second depth information.

FIG. 4 shows a usage situation when the depth processing system in FIG. 1 is adopted to track the skeleton model.

FIG. 5 shows a depth processing system according to another embodiment of the present invention.

FIG. 6 shows the three-dimensional point cloud generated by the depth processing system in FIG. 5.

FIG. 7 shows a flow chart of an operating method of the depth processing system in FIG. 1 according to one embodiment of the present invention.

FIG. 8 shows a flow chart for performing the synchronization function according to one embodiment of the present invention.

FIG. 9 shows a flow chart for performing the synchronization function according to another embodiment of the present invention.

FIG. 10 is a diagram illustrating a depth processing system according to another embodiment of the present invention.

FIG. 11 is a diagram taking the depth capturing device as an example to illustrate the depth capturing device being a time of flight device with 180-degree field-of-view.

FIG. 12 is a diagram illustrating a depth capturing device according to another embodiment of the present invention.

FIG. 13 is a diagram illustrating a cross-section view of a depth capturing device according to another embodiment of the present invention.

FIG. 14 is a flowchart illustrating an operational method of the depth processing system.

### DETAILED DESCRIPTION

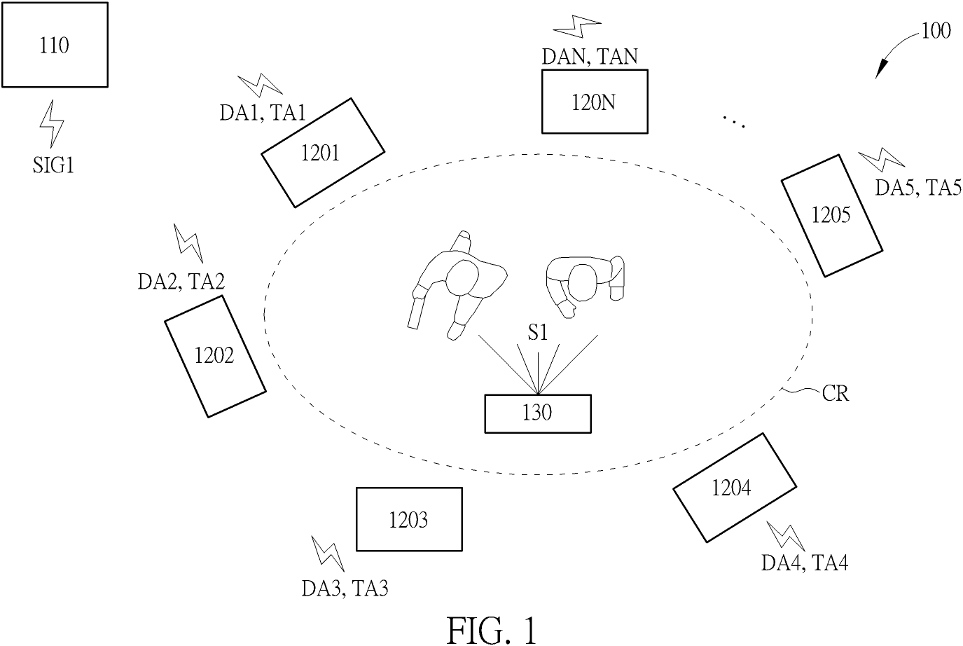

FIG. 1 shows a depth processing system 100 according to one embodiment of the present invention. The depth processing system 100 includes a host 110 and a plurality of depth capturing devices 1201 to 120N, where N is an integer greater than 1.

The depth capturing devices 1201 to 120N can be disposed around a specific region CR, and the depth capturing devices 1201 to 120N each can generate a piece of depth information of the specific region CR according to its own corresponding viewing point. In some embodiments of the present invention, the depth capturing devices 1201 to 120N can use the same approach or different approaches, such as binocular vision, structured light, time of flight (ToF), etc., to generate the depth information of the specific region CR from different viewing points. The host can transform the depth information generated by the depth capturing devices 1201 to 120N into the same space coordinate system according to the positions and the capturing angles of the depth capturing devices 1201 to 120N, and further combine the depth information generated by the depth capturing devices 1201 to 120N to generate the three-dimensional (3D) three-dimensional point cloud corresponding to the specific region CR to provide completed 3D environment information of the specific region CR.

In some embodiments, the parameters of the depth capturing devices 1201 to 120N, such as the positions, the capturing angles, the focal lengths, and the resolutions, can be determined in advance so these parameters can be stored in the host in the beginning, allowing the host 110 to combine the depth information generated by the depth capturing devices 1201 to 120N reasonably. In addition, since the positions and capturing angles may be slightly different when the depth capturing devices 1201 to 120N are practically installed, the host 110 may perform a calibration function to calibrate the parameters of the depth capturing devices 1201 to 120N, ensuring the depth information generated by the depth capturing devices 1201 to 120N can be combined jointly. In some embodiments, the depth information may also include color information.

In addition, the object in the specific region CR may move so the host 110 has to use the depth information generated by the depth capturing devices 1201 to 120N at similar times to generate the correct 3D three-dimensional point cloud. To control the depth capturing devices 1201 to 120N to generate the depth information synchronously, the host 110 can perform a synchronization function.

When the host 110 performs the synchronization function, the host 110 can, for example, transmit a first synchronization signal SIG1 to the depth capturing devices 1201 to 120N. In some embodiments, the host 110 can transmit the first synchronization signal SIG1 to the depth capturing devices 1201 to 120N through wireless communications, wired communications, or both types of communications. After receiving the first synchronization signal SIG1, the depth capturing devices 1201 to 120N can generate pieces of first depth information DA1 to DAN and transmit the pieces of first depth information DA1 to DAN along with the first capturing times TA1 to TAN of capturing the pieces of first depth information DA1 to DAN to the host 110.

In the present embodiment, from capturing information to completing the depth information generation, the depth capturing devices 1201 to 120N may require different lengths of time; therefore, to ensure the synchronization function to effectively control the depth capturing devices 1201 to 120N for generating the depth information synchronously, the first capturing times TA1 to TAN of capturing the pieces of first depth information DA1 to DAN should be the times at which the pieces of the first depth information DA1 to DAN are captured, instead of the times at which the pieces of the first depth information DA1 to DAN are generated.

In addition, since the distances via the communication paths to the host 110 may be different for the depth capturing devices 1201 to 120N, and the physical conditions and the internal processing speeds may also be different, the depth capturing devices 1201 to 120N may receive the first synchronization signal SIG1 at different times, and the first capturing times TA1 to TAN may also be different. In some embodiments of the present invention, after the host receives the pieces of first depth information DA1 to DAN and the first capturing times TA1 to TAN, the host 110 can sort the first capturing times TA1 to TAN and generate an adjustment time corresponding to each of the depth capturing devices 1201 to 120N according to the first capturing times TA1 to TAN. Therefore, next time, when each of the depth capturing devices 1201 to 120N receives the synchronization signal from the host 110, each of the depth capturing devices 1201 to 120N can adjust the time for capturing the depth information according to the adjustment time.

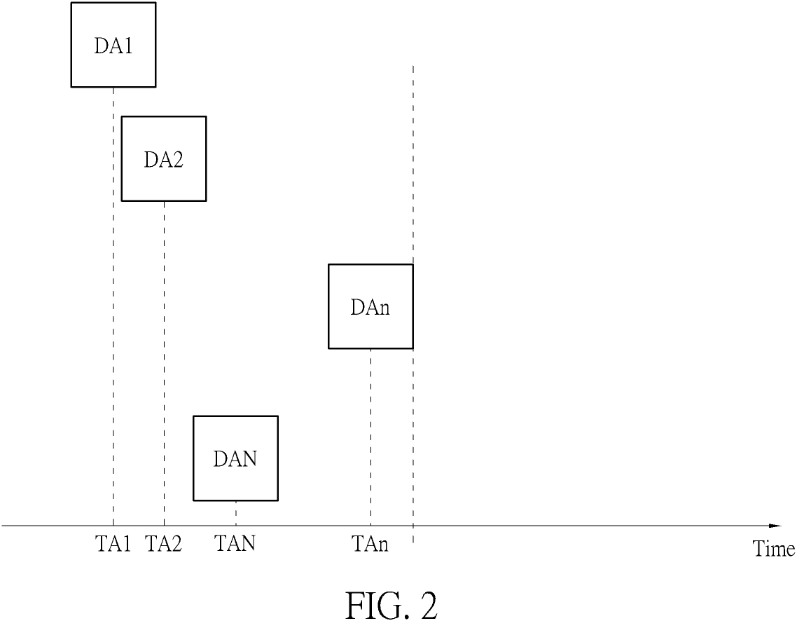

FIG. 2 shows the timing diagram of the first capturing times TA1 to TAN of the depth capturing devices 1201 to 120N. In FIG. 2, the first capturing time TA1 for capturing the piece of first depth information DA1 is the earliest among the first capturing times TA1 to TAN, and the first capturing time TAn is the latest among the first capturing times TA1 to TAN, where N≥n>1. To prevent the depth information from being combined unreasonably due to the large timing variation between the depth capturing devices 1201 to 120N, the host 110 can take the latest first capturing time TAn as a reference point, and request the depth capturing devices to capture depth information before the first capturing time TAn to postpone the capturing times. For example, in FIG. 2, the difference between the first capturing times TA1 and TAn may be 1.5 ms so the host 110 may set the adjustment time, for example, to be 1 ms, for the depth capturing device 1201 accordingly. Consequently, next time, when the host 110 transmits a second synchronization signal to the depth capturing device 1201, the depth capturing device 1201 would determine when to capture the piece of second depth information according to the adjustment time set by the host 110.

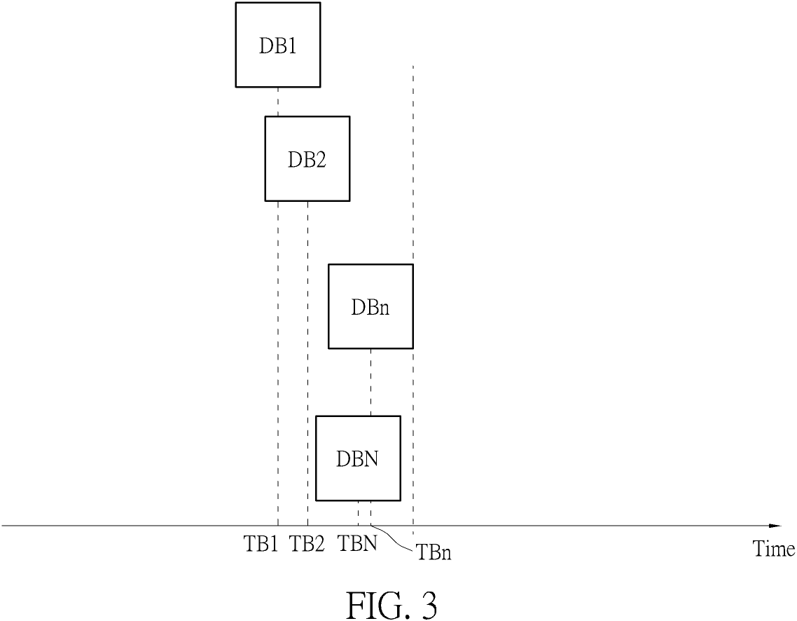

FIG. 3 shows the timing diagram of the second capturing times TB1 to TBN for capturing the pieces of second depth information DB1 to DBN after the depth capturing devices 1201 to 120N receive the second synchronization signal. In FIG. 3, when the depth capturing device 1201 receives the second synchronization signal, the depth capturing device 1201 will delay 1 ms and then capture the piece of second depth information DB1. Therefore, the difference between the second capturing time TB1 for capturing the piece of second depth information DB1 and the second capturing time TBn for capturing the piece of second depth information DBn can be reduced. In some embodiments, the host 110 can, for example but not limited to, delay the capturing times of the depth capturing devices 1201 to 120N by controlling the clock frequencies or the v-blank signals in image sensors of the depth capturing devices 1201 to 120N.

Similarly, the host 110 can set the adjustment times for the depth capturing devices 1202 to 120N according to their first capturing times TA2 to TAN. Therefore, the second capturing times TB1 to TBN of the depth capturing devices 1201 to 120N are more centralized in FIG. 3 than the first capturing times TA1 to TAN of the depth capturing devices 1201 to 120N in FIG. 2 overall. Consequently, the times at which the depth capturing devices 1201 to 120N capture the depth information can be better synchronized.

Furthermore, since the exterior and the interior conditions of the depth capturing devices 1201 to 120N can vary from time to time, for example the internal clock signals of the depth capturing devices 1201 to 120N may shift with different levels as time goes by, the host 110 can perform the synchronization function continuously in some embodiments, ensuring the depth capturing devices 1201 to 120N to keep generating the depth information synchronously.

In some embodiments of the present invention, the host 110 can use other approaches to perform the synchronization function. For example, the host 110 can send a series of timing signals to the depth capturing devices 1201 to 120N continuously. The series of timing signals sent by the host 110 include the updated timing information at the present, so when capturing the depth information, the depth capturing devices 1201 to 120N can record the capturing times according to the timing signals received when the corresponding pieces of depth information are captured and transmit the capturing times and the pieces of depth information to the host 110. In some embodiments, the distances between the depth capturing devices may be rather long, the time for the timing signals being received by the depth capturing devices may also be different, and the transmission times to the host 110 are also different. Therefore, the host 110 can reorder the capturing times of the depth capturing devices 1201 to 120N as shown in FIG. 2 after making adjustment according to different transmission times of the depth capturing devices. To prevent the depth information from being combined unreasonably due to the large timing variation between the depth capturing devices 1201 to 120N, the host 110 can generate the adjustment time corresponding to each of the depth capturing devices 1201 to 120N according to the capturing times TA1 to TAN, and the depth capturing devices 1201 to 120N can adjust a delay time or a frequency for capturing depth information.

For example, in FIG. 2, the host 110 can take the latest first capturing time TAn as a reference point, and request the depth capturing devices that capture the pieces of depth information before the first capturing time TAn to reduce their capturing frequencies or to increase their delay times. For example, the depth capturing device 1201 may reduce its capturing frequency or increase its delay time. Consequently, the depth capturing devices 1201 to 120N would become synchronized when capturing the depth information.

Although in the aforementioned embodiments, the host 110 can take the latest first capturing time TAn as the reference point to postpone other depth capturing devices, it is not to limit the present invention. In some other embodiments, if the system permits, the host 110 can also request the depth capturing device 120N to capture the depth information earlier or to speed up the capturing frequency to match with other depth capturing devices.

In addition, in some other embodiments, the adjustment times set by the host 110 are mainly used to adjust the times at which the depth capturing devices 1201 to 120N capture the exterior information for generating the depth information. For the synchronization between the right-eye image and the left-eye image required by the depth capturing devices 1201 to 120N when using the binocular vision, the internal clock signals of the depth capturing devices 1201 to 120N should be able to control the sensors for synchronization.

As mentioned, the host 110 may receive the pieces of depth information generated by the depth capturing devices 1201 to 120N at different times. In this case, to ensure the depth capturing devices 1201 to 120N can continue generating the depth information synchronously to provide the real-time 3D three-dimensional point cloud, the host 110 can set the scan period to ensure the depth capturing devices 1201 to 120N to generate the synchronized depth information periodically. In some embodiments, the host 110 can set the scan period according to the latest receiving time among the receiving times for receiving the depth information generated by the depth capturing devices 1201 to 120N. That is, the host 110 can take the depth capturing device that requires the longest transmission time among the depth capturing devices 1201 to 120N as a reference and set the scan period according to its transmission time. Consequently, it can be ensured that within a scan period, every depth capturing devices 1201 to 120N will be able to generate and transmit the depth information to the host 110 in time.

In addition, to prevent the depth processing system 100 from halting due to parts of the depth capturing devices being broken down, the host 110 can determine that the depth capturing devices have dropped their frames if the host 110 sends the synchronization signal and fails to receive any signals from those depth capturing devices within a buffering time after the scan period. In this case, the host 110 will move on to the next scan period so the other depth capturing devices can keep generating the depth information.

For example, the scan period of the depth processing system 100 can be 10 ms, and the buffering time can be 2 ms. In this case, after the host 110 sends the synchronization signal, if the host fails to receive the depth information generated by the depth capturing device 1201 within 12 ms, then the host 110 will determine that the depth capturing device 1201 has dropped its frame and will move on to the next scan period so as to avoid permanent idle.

In FIG. 1, the depth capturing devices 1201 to 120N can generate the depth information according to different methods, for example, some of the depth capturing devices may use structured light to improve the accuracy of the depth information when the ambient light or the texture on the object is not sufficient. For example, in FIG. 1, the depth capturing devices 1203 and 1204 may use the binocular vision algorithm to generate the depth information with the assistance of structured light. In this case, the depth processing system 100 can further include at least one structured light source 130. The structured light source 130 can emit structured light S1 to the specific region CR. In some embodiments of the present invention, the structured light S1 can project a specific pattern. When the structured light S1 is projected to the object, the specific pattern will be changed by different levels according to the surface information of the object. Therefore, according to the change of the pattern, the depth capturing device can derive the depth information about the surface information of the object.

In some embodiments, the structured light 130 can be separated from the depth capturing devices 1201 and 120N, and the structured light S1 projected by the structured light source 130 can be used by two or more depth capturing devices for generating the depth information. For example, in FIG. 1, the depth capturing devices 1203 and 1204 can both generate the depth information according to the structured light S1. In other words, different depth capturing devices can use the same structured light to generate the corresponding depth information. Consequently, the hardware design of the depth capturing devices can be simplified. Furthermore, since the structured light source 130 can be installed independently from the depth capturing devices 1201 to 120N, the structured light source 130 can be disposed closer to the object to be scanned without being limited by the position of the depth capturing devices 1201 to 120N so as to improve the flexibility of designing the depth processing system 100.

In addition, if the ambient light and the texture of the object are sufficient and the binocular vision algorithm alone is enough to generate accurate depth information meeting the requirement, then the structured light source 130 may not be necessary. In this case, the depth processing system 100 can turn off the structured light source 130, or even omit the structured light source 130 according to the usage situations.

In some embodiments, after the host 110 obtains the 3D three-dimensional point cloud, the host 110 can generate a mesh according to the 3D three-dimensional point cloud and generate the real-time 3D environment information according to the mesh. With the real-time 3D environment information corresponding to the specific region CR, the depth processing system 100 can monitor the object movement in the specific region CR and support many kinds of applications.

For example, in some embodiments, the user can track interested objects in the depth processing system 100 with, for example, face recognition, radio frequency identification, or card registration, so that the depth processing system 100 can identify the interested objects to be tracked. Then, the host 110 can use the real-time 3D environment information generated according to the mesh or the 3D three-dimensional point cloud to track the interested objects and determine the positions and the actions of the interested objects. For example, the specific region CR interested by the depth processing system 100 can be a target such as a hospital, nursing home, or jail. Therefore, the depth processing system 100 can monitor the action and the position of patients or prisoners and perform corresponding functions according to their actions. For example, if the depth processing system 100 determines that the patient has fallen down or the prisoner is breaking out of the prison, then a notification or a warning can be issued. Or, the depth processing system 100 can be applied to a shopping mall. In this case, the interested objects can be customers, and the depth processing system 100 can record the action routes of the customers, derive the shopping habits with big data analysis, and provide suitable services for customers.

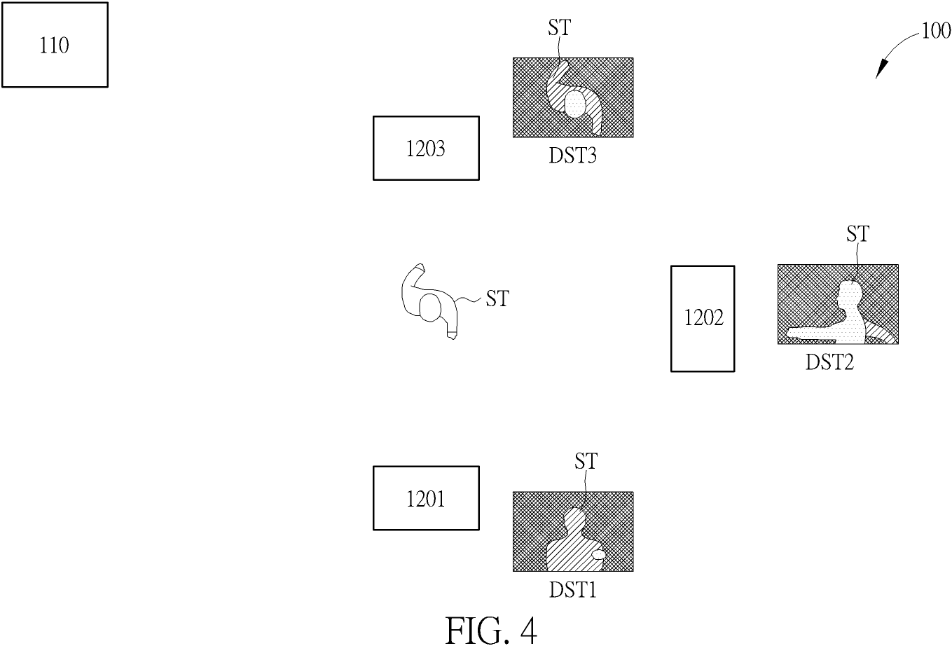

In addition, the depth processing system 100 can also be used to track the motion of the skeleton model. To track the motion of the skeleton model, the user can wear the costume with trackers or with special colors for the depth capturing devices 1201 to 120N in the depth processing system 100 to track the motion of each part of the skeleton model. FIG. 4 shows a usage situation when the depth processing system 100 is adopted to track the skeleton model ST. In FIG. 4, the depth capturing devices 1201 to 1203 of the depth processing system 100 can capture the depth information of the skeleton mode ST from different viewing points. That is, the depth capturing device 1201 can observe the skeleton model ST from the front, the depth capturing device 1202 can observe the skeleton model ST from the side, and the depth capturing device 1203 can observe the skeleton model ST from the top. The depth capturing devices 1201 to 1203 can respectively generate the depth maps DST1, DST2, and DST3 of the skeleton model ST according to their viewing points.

In prior art, when obtaining the depth information of the skeleton model from a single viewing point, the completed action of the skeleton model ST usually cannot be derived due to the limitation of the single viewing point. For example, in the depth map DST1 generated by the depth capturing device 1201, since the body of the skeleton model ST blocks its right arm, we are not able to know what the action of its right arm is. However, with the depth maps DST1, DST2, and DST3 generated by the depth capturing devices 1201 to 1203, the depth processing system 100 can integrate the completed action of the skeleton model ST.

In some embodiments, the host 110 can determine the actions of the skeleton model ST in the specific region CR according to the moving points in the 3D three-dimensional point cloud. Since the points remain still in a long time may belong to the background while the moving points are more likely to be related to the skeleton model ST, the host 110 can skip the calculation for regions with still points and focus on regions with moving points. Consequently, the computation burden of the host 110 can be reduced.

Furthermore, in some other embodiments, the host 110 can generate the depth information of the skeleton model ST corresponding to different view points according to the real-time 3D environment information provided by the mesh to determine the action of the skeleton model ST. In other words, in the case that the depth processing system 100 has already derived the completed 3D environment information, the depth processing system 100 can generate depth information corresponding to the virtual viewing points required by the user. For example, after the depth processing system 100 obtains the completed 3D environment information, the depth processing system 100 can generate the depth information with viewing points in front of, in back of, on the left of, on the right of, and/or above the skeleton model ST. Therefore, the depth processing system 100 can determine the action of the skeleton model ST according to the depth information corresponding to these different viewing points, and the action of the skeleton model can be tracked accurately.

In addition, in some embodiments, the depth processing system 100 can also transform the 3D three-dimensional point cloud to have a format compatible with the machine learning algorithms. Since the 3D three-dimensional point cloud does not have a fixed format, and the recorded order of the points are random, it can be difficult to be adopted by other applications. The machine learning algorithms or the deep learning algorithms are usually used to recognize objects in two-dimensional images. However, to process the two-dimensional image for object recognition efficiently, the two-dimensional images are usually stored in a fixed format, for example, the image can be stored with pixels having red, blue, and green color values and arranged row by row or column by column. Corresponding to the two-dimensional images, the 3D images can also be stored with voxels having red, blue and green color values and arranged according to their positions in the space.

However, the depth processing system 100 is mainly used to provide depth information of objects, so whether to provide the color information or not is often an open option. And sometimes, it is also not necessary to recognize the objects with their colors for the machine learning algorithms or the deep learning algorithms. That is, the object may be recognized simply by its shape. Therefore, in some embodiments of the present invention, the depth processing system 100 can store the 3D three-dimensional point cloud as a plurality of binary voxels in a plurality of unit spaces for the usage of the machine learning algorithms or the deep learning algorithms.

For example, the host 110 can divide the space containing the 3D three-dimensional point cloud into a plurality of unit spaces, and each of the unit spaces is corresponding to a voxel. The host 110 can determine the value of each voxel by checking if there are more than a predetermined number of points in the corresponding unit space. For example, when a first unit space has more than a predetermined number of points, for example, more than 10 points, the host 110 can set the first voxel corresponding to the first unit space to have a first bit value, such as 1, meaning that there is an object existed in the first voxel. Contrarily, when a second unit space has no more than a predetermined number of points, the host 110 can set the second voxel corresponding to the second unit space to have a second bit value, such as 0, meaning that there’s no object in the second voxel. Consequently, the three-dimensional point cloud can be stored in a binary voxel format, allowing the depth information generated by the depth processing system 100 to be adopted widely by different applications while saving the memory space.

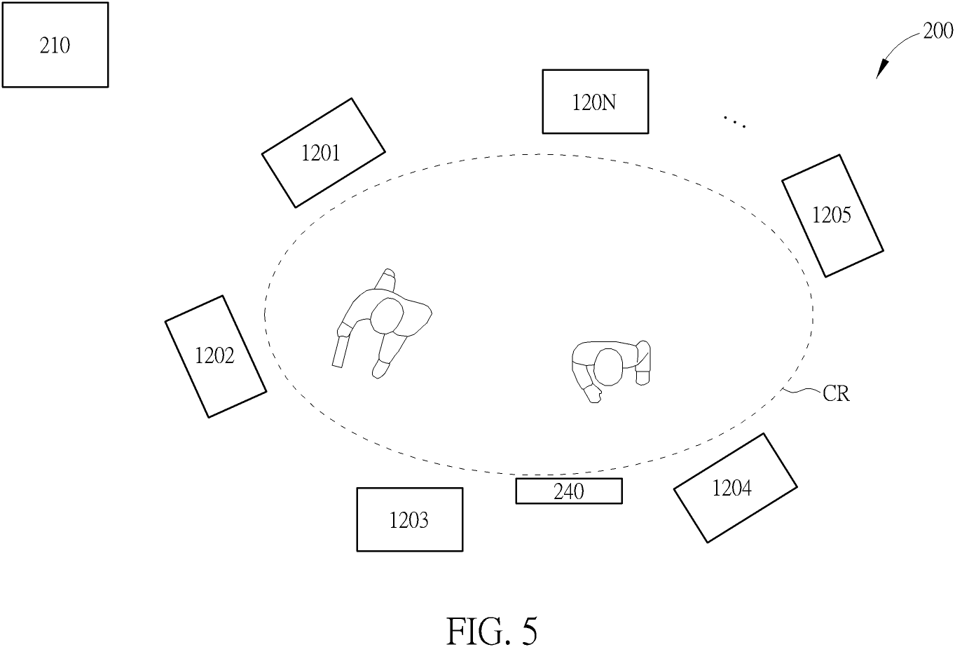

FIG. 5 shows a depth processing system 200 according to another embodiment of the present invention. The depth processing systems 100 and 200 have similar structures and can be operated with similar principles. However, the depth processing system 200 further includes an interactive device 240. The interactive device 240 can perform a function corresponding to an action of a user within an effective scope of the interactive device 240. For example, the depth processing system 200 can be disposed in a shopping mall, and the depth processing system 200 can be used to observe the actions of the customers. The interactive device 240 can, for example, include a display panel. When the depth processing system 200 identifies that a customer is walking into the effective scope of the interactive device 240, the depth processing system 200 can further check the customer’s identification and provide information possibly needed by the customer according to his/her identification. For example, according to the customer’s consuming history, corresponding advertisement which may interest the customer can be displayed. In addition, since the depth processing system 200 can provide the depth information about the customer, the interactive device 240 can also interact with the customer by determining the customer’s actions, such as displaying the item selected by the customer with his/her hand gestures.

In other words, since the depth processing system 200 can provide the completed 3D environment information, the interactive device 240 can obtain the corresponding depth information without capturing or processing the depth information. Therefore, the hardware design can be simplified, and the usage flexibility can be improved.

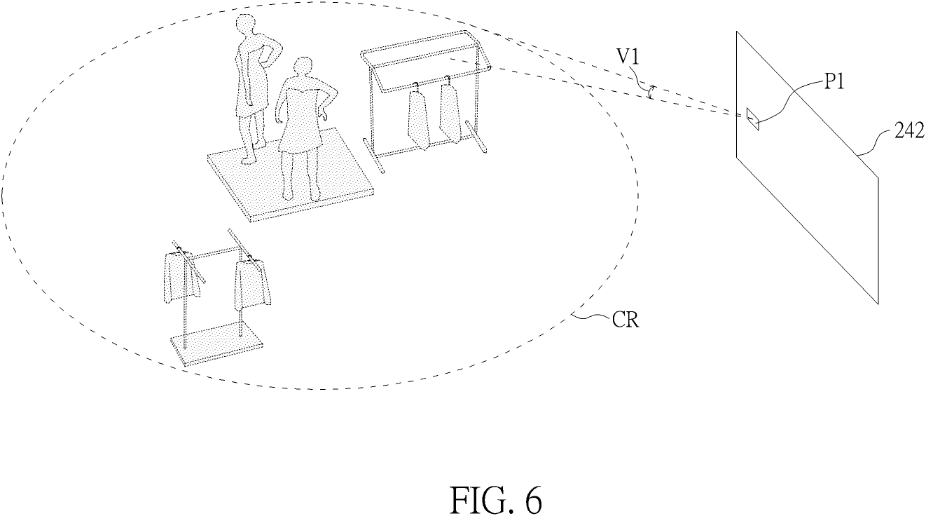

In some embodiments, the host 210 can provide the depth information corresponding to the virtual viewing point of the interactive device 240 according to the 3D environmental information provided by the mesh or the 3D three-dimensional point cloud so the interactive device 240 can determine the user’s actions and the positions relative to the interactive device 240 accordingly. For example, FIG. 6 shows the 3D three-dimensional point cloud generated by the depth processing system 200. The depth processing system 200 can choose the virtual viewing point according to the position of the interactive device 240 and generate the depth information corresponding to the interactive device 240 according to the 3D three-dimensional point cloud in FIG. 6. That is, the depth processing system 200 can generate the depth information of the specific region CR as if it were observed by the interactive device 240.

In FIG. 6, the depth information of the specific region CR observed from the position of the interactive device 240 can be presented by the depth map 242. In the depth map 242, each pixel can be corresponding to a specific viewing field when observing the specific region CR from the interactive device 240. For example, in FIG. 6, the content of the pixel P1 is generated by the observing result with the viewing field V1. In this case, the host 210 can determine which is the nearest object in the viewing field V1 when watching objects from the position of the interactive device 240. In the viewing field V1, since the further object would be blocked by the closers object, the host 210 will take the depth of the object nearest to the interactive device 240 as the value of the pixel P1.

In addition, when using the 3D three-dimensional point cloud to generate the depth information, since the depth information may be corresponding to a viewing point different from the viewing point for generating the 3D three-dimensional point cloud, defects and holes may appear in some parts of the depth information due to lack of information. In this case, the host 210 can check if there are more than a predetermined number of points in a predetermined region. If there are more than the predetermined number of points, meaning that the information in the predetermined region is rather reliable, then the host 210 can choose the distance from the nearest point to the projection plane of the depth map 242 to be the depth value, or derive the depth value by combining different distance values with proper weightings. However, if there are no more than the predetermined number of points in such predetermined region, then the host 210 can further expand the region until the host 210 can finally find enough points in the expanded region. However, to prevent the host 210 from expanding the region indefinitely and causing depth information with an unacceptable inaccuracy, the host 210 can further limit the number of expansions. Once the host 210 cannot find enough points after the limited number of expansions, the pixel would be set as invalid.

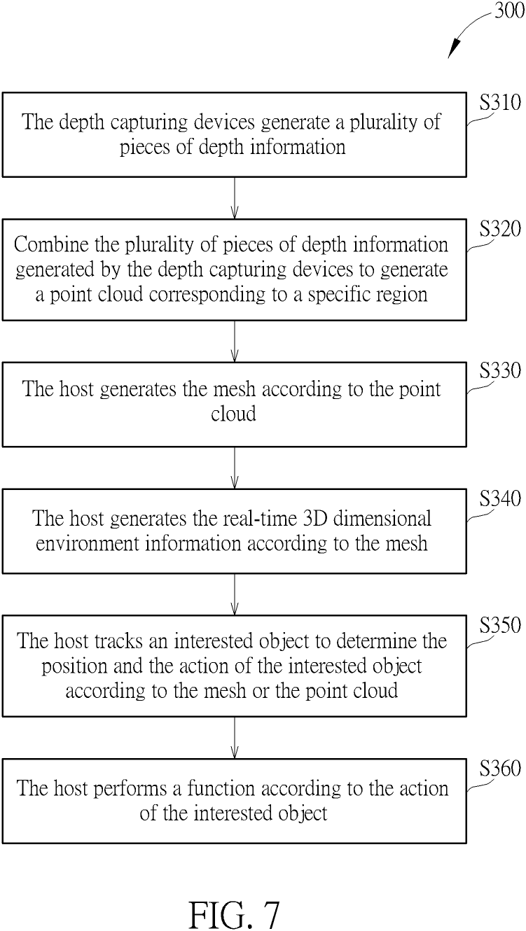

FIG. 7 shows a flow chart of an operating method 300 of the depth processing system 100 according to one embodiment of the present invention. The method 300 includes steps S310 to S360.
S310: the depth capturing devices 1201 to 120N generate a plurality of pieces of depth information;
S320: combine the plurality of pieces of depth information generated by the depth capturing devices 1201 to 120N to generate a three-dimensional point cloud corresponding to a specific region CR;
S330: the host 110 generates the mesh according to the three-dimensional point cloud;
S340: the host 110 generates the real-time 3D dimensional environment information according to the mesh;
S350: the host 110 tracks an interested object to determine the position and the action of the interested object according to the mesh or the three-dimensional point cloud;
S360 : the host 110 performs a function according to the action of the interested object.

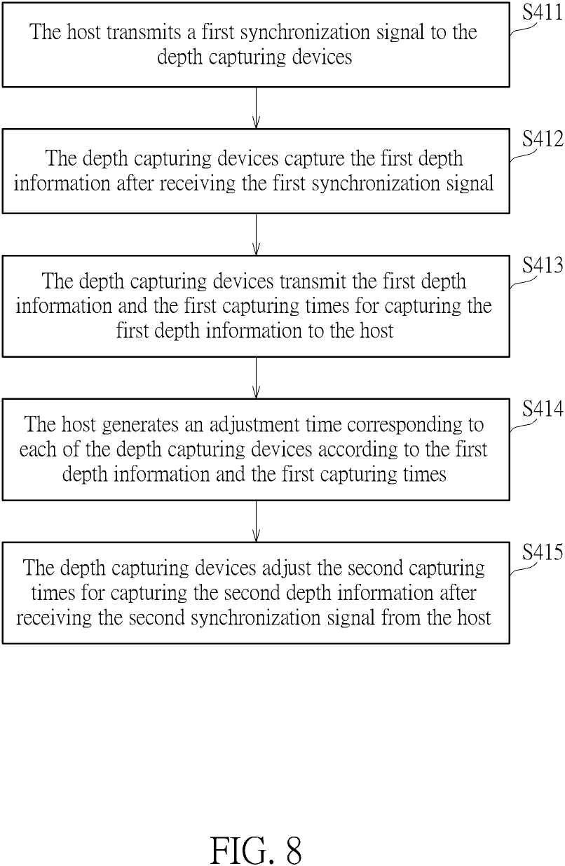

In some embodiments, to allow the depth capturing devices 1201 to 120N to generate the depth information synchronously for producing the three-dimensional point cloud, the method 300 can further include a step for the host 110 to perform a synchronization function. FIG. 8 shows a flow chart for performing the synchronization function according to one embodiment of the present invention. The method for performing the synchronization function can include steps S411 to S415.
S411: the host 110 transmits a first synchronization signal SIG1 to the depth capturing devices 1201 to 120N;
S412: the depth capturing devices 1201 to 120N capture the first depth information DA1 to DAN after receiving the first synchronization signal SIG1;
S413: the depth capturing devices 1201 to 120N transmit the first depth information DA1 to DAN and the first capturing times TA1 to TAN for capturing the first depth information DA1 to DAN to the host 110;
S414 : the host 110 generates an adjustment time corresponding to each of the depth capturing devices 1201 to 120N according to the first depth information DA1 to DAN and the first capturing times TA1 to TAN;
S415: the depth capturing devices 1201 to 120N adjust the second capturing times TB1 to TBN for capturing the second depth information DB1 to DBN after receiving the second synchronization signal from the host 110.

With the synchronization function, the depth capturing devices 1201 to 120N can generate the depth information synchronously. Therefore, in step S320, the depth information generated by the depth capturing devices 1201 to 120N can be combined to a uniform coordinate system for generating the 3D three-dimensional point cloud of the specific region CR according to the positions and the capturing angles of the depth capturing devices 1201 to 120N.

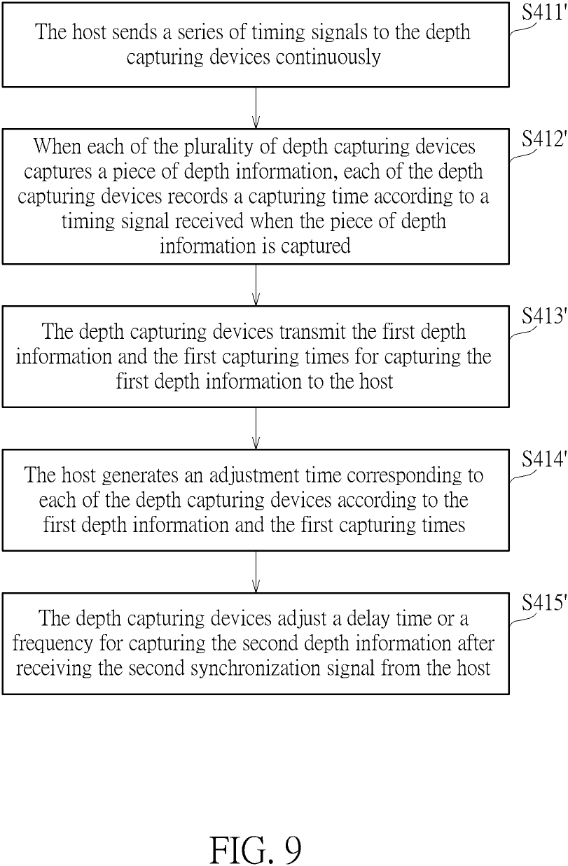

In some embodiments, the synchronization function can be performed by other approaches. FIG. 9 shows a flow chart for performing the synchronization function according to another embodiment of the present invention. The method for performing the synchronization function can include steps S411′ to S415′.
S411′ : the host 110 sends a series of timing signals to the depth capturing devices 1201 to 120N continuously;
S412′: when each of the plurality of depth capturing devices 1201 to 120N captures a piece of depth information DA1 to DAN, each of the depth capturing devices 1201 to 120N records a capturing time according to a timing signal received when the piece of depth information DA1 to DAN is captured;
S413′: the depth capturing devices 1201 to 120N transmit the first depth information DA1 to DAN and the first capturing times TA1 to TAN for capturing the first depth information DA1 to DAN to the host 110;
S414′ : the host 110 generates an adjustment time corresponding to each of the depth capturing devices 1201 to 120N according to the first depth information DA1 to DAN and the first capturing times TA1 to TAN;
S415′: the depth capturing devices 1201 to 120N adjust a delay time or a frequency for capturing the second depth information after receiving the second synchronization signal from the host 110.

In addition, in some embodiments, the host 110 may receive the depth information generated by the depth capturing devices 1201 to 120N at different times, and the method 300 can also have the host 110 set the scan period according to the latest receiving time of the plurality of receiving times, ensuring every depth capturing devices 1201 to 120N will be able to generate and transmit the depth information to the host 110 in time within a scan period. Also, if the host 110 sends the synchronization signal and fails to receive any signals from some depth capturing devices within a buffering time after the scan period, then the host 110 can determine that those depth capturing devices have dropped their frames and move on to the following operations, preventing the depth processing system 100 from idling indefinitely.

After the mesh and the 3D environment information corresponding to the specific region CR are generated in the steps S330 and S340, the depth processing system 100 can be used in many applications. For example, when the depth processing system 100 is applied to a hospital or a jail, the depth processing system 100 can track the positions and the actions of patients or prisoners through steps S350 and S360, and perform the corresponding functions according to the positions and the actions of the patients or the prisoners, such as providing assistance or issuing notifications.

In addition, the depth processing system 100 can also be applied to a shopping mall. In this case, the method 300 can further record the action route of the interested object, such as the customers, derive the shopping habits with big data analysis, and provide suitable services for the customers.

In some embodiments, the method 300 can also be applied to the depth processing system 200. Since the depth processing system 200 further includes an interactive device 240, the depth processing system 200 can provide the depth information corresponding to the virtual viewing point of the interactive device 240 so the interactive device 240 can determine the user’s actions and the positions corresponding to the interactive device 240 accordingly. When a customer is walking into the effective scope of the interactive device 240, the interactive device 240 can perform functions corresponding to the customer’s actions. For example, when the user moves closer, the interactive device 240 can display the advertisement or the service items, and when the user changes his/her gestures, the interactive device 240 can display the selected item accordingly.

In addition, the depth processing system 100 can also be applied to track the motions of skeleton models. For example, the method 300 may include the host 110 generating a plurality of pieces of depth information with respect to different viewing points corresponding to the skeleton model in the specific region CR according to the mesh for determining the action of the skeleton model, or determine the action of the skeleton model in the specific region CR according to a plurality of moving points in the 3D three-dimensional point cloud.

Furthermore, in some embodiments, to allow the real-time 3D environment information generated by the depth processing system 100 to be widely applied, the method 300 can also include storing the 3D information generated by the depth processing system 100 in a binary-voxel format. For example, the method 300 can include the host 110 dividing the space containing the 3D three-dimensional point cloud into a plurality of unit spaces, where each of the unit space is corresponding to a voxel. When a first unit space has more than a predetermined number of points, the host 110 can set the voxel corresponding to the first unit space to have a first bit value. Also, when a second unit space has no more than the predetermined number of points, the host 110 can set the voxel corresponding to the second unit space to have a second bit value. That is, the depth processing system 100 can store the 3D information as binary voxels without color information, allowing the 3D information to be used by machine learning algorithms or deep learning algorithms.

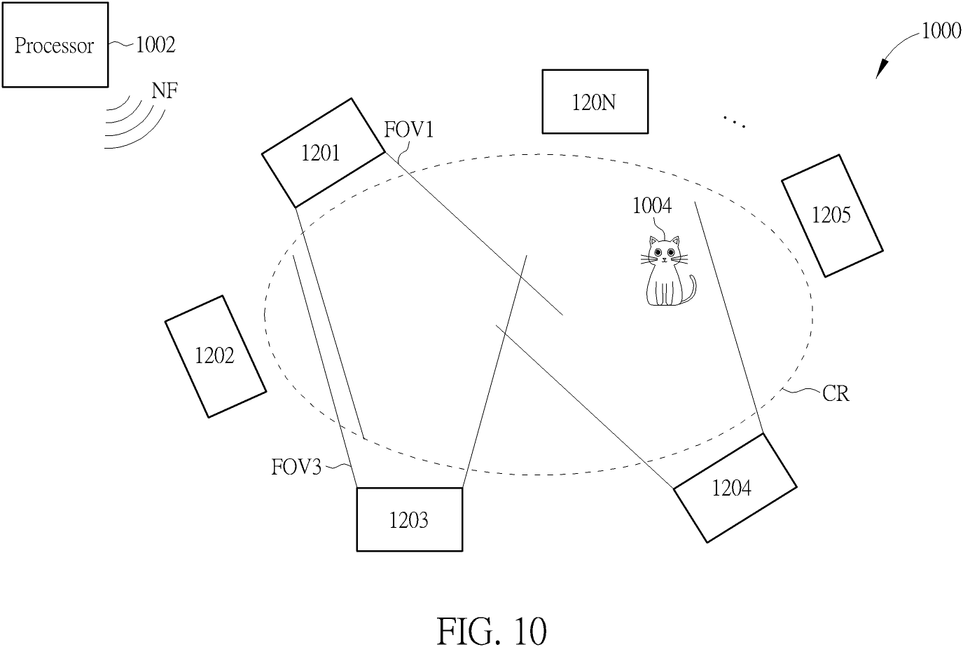

Please refer to FIG. 10. FIG. 10 is a diagram illustrating a depth processing system 1000 according to another embodiment of the present invention. As shown in FIG. 10, the depth processing system 1000 includes a processor 1002 and a plurality of depth capturing devices 1201∼120N, wherein N is an integer greater than 1, the processor 1002 in installed in a host (not shown in FIG. 10), and structures and operational principles of the plurality of depth capturing devices 1201∼120N of the depth processing system 1000 are similar to structures and operational principles of the plurality of depth capturing devices 1201~120N of the depth processing system 100. In addition, one of ordinary skilled in the art should know that each depth capturing device of the plurality of depth capturing devices 1201~120N at least includes lens and an image sensor (e.g. a charge-coupled device (CCD) image sensor or a complementary metal-oxide-semiconductor (CMOS) image sensor), so descriptions for a structure of the each depth capturing device is omitted for simplicity. In addition, the processor 1002 can be used for fusing a plurality of depth information generated by the plurality of depth capturing devices 1201~120N to generate a three-dimensional point cloud/panorama depths corresponding to a specific region CR to provide complete three-dimensional environment information corresponding to the specific region CR. Therefore, after the processor 1002 provides the three-dimensional environment information corresponding to the specific region CR, when a moving object 1004 (e.g. a cat) enters the specific region CR from outside of the specific region CR, because a field-of-view (FOV) FOV1 of the depth capturing device 1201 and a field-of-view FOV3 of the depth capturing device 1203 do not cover the moving object 1004, the processor 1002 can generate notification information NF corresponding to the moving object 1004 to the depth capturing devices 1201, 1203. Therefore, users corresponding to the depth capturing devices 1201, 1203 can know that the moving object 1004 has been in the specific region CR and may enter a region covered by the field-of-views FOV1, FOV3 of the depth capturing devices 1201, 1203 within the specific region CR through the notification information NF. That is, the users corresponding to the depth capturing devices 1201, 1203 can execute corresponding actions for coming of the moving object 1004 through the notification information NF (e.g. the users corresponding to the depth capturing devices 1201, 1203 can notify people in the specific area CR that the moving object 1004 is going to enter the region covered by the field-of-views FOV1, FOV3 of the depth capturing devices 1201, 1203 within the specific area CR through microphones). In addition, as shown in FIG. 10, the plurality of depth capturing devices 1201~120N communicate with the processor 1002 in a wireless manner. But, in another embodiment of the present invention, the plurality of depth capturing devices 1201~120N communicate with the processor 1002 in a wire manner.

In one embodiment of the present invention, for making real-time three-dimensional (3D) information generated by the depth processing system 1000 be conveniently widely applied, the 3D information generated by the depth processing system 1000 can be stored in a binary-voxel format. For example, all the plurality of depth information generated by the plurality of depth capturing devices 1201~120N and the three-dimensional point cloud/the panorama depths corresponding to the specific region CR are stored in the binary-voxel format. Taking the three-dimensional point cloud as an example for more detail description, first, space occupied by the three-dimensional point cloud is divided into a plurality of unit spaces, wherein each unit space corresponds to a voxel. When a first unit space has points more than a predetermined number, a first voxel corresponding to the first unit space is set to be first bit value, and when a second unit space has points no more than a predetermined number, a second voxel corresponding to the second unit space is set to be second bit value. That is, the depth processing system 1000 can store the 3D information as binary voxels without color information, so as to be used by machine learning algorithms or deep learning algorithms, wherein that taking the three-dimensional point cloud as an example can be referred to FIG. 7 and corresponding descriptions, so further description thereof is omitted for simplicity.

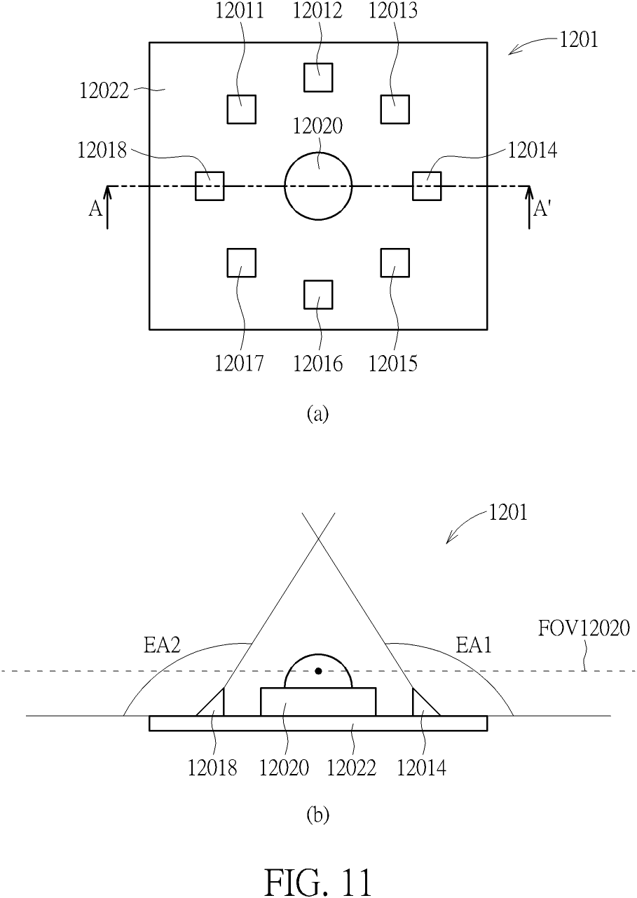

In one embodiment of the present invention, each depth capturing device of the plurality of depth capturing devices 1201~120N is a time of flight (ToF) device. Then, please refer to FIG. 11. FIG. 11 is a diagram taking the depth capturing device 1201 as an example to illustrate the depth capturing device 1201 being a time of flight device with 180-degree field-of-view, wherein FIG. 11 (a) is a top view of the depth capturing device 1201, and FIG. 11 (b) is a cross-section view corresponding to an A-A′ cutting line in FIG. 11 (a) . As shown in FIG. 11 (a) , the depth capturing device 1201 includes light sources 12011∼12018, a sensor 12020, and a supporter 12022, wherein the light sources 12011∼12018 and the sensor 12020 are installed on the supporter 12022. But, in another embodiment of the present invention, the light sources 12011∼12018 and the sensor 12020 are installed on different supporters, respectively. Each light source of the light sources 12011∼12018 is a light emitting diode (LED), or a laser diode (LD), or any light-emitting element with other light-emitting technologies, and light emitted by the each light source is infrared light (meanwhile, the sensor 12020 is an infrared light sensor). But, the present invention is not limited to light emitted by the each light source being infrared light, that is, for example, light emitted by the each light source is visible light. In addition, the light sources 12011∼12018 need to be controlled to simultaneously emit infrared light toward the specific region CR, and the sensor 12020 is used for sensing reflected light (corresponding to infrared light emitted by the light sources 12011∼12018) generated by an object within a field-of-view of the sensor 1202 and generating depth information corresponding to the object accordingly. In addition, the present invention is not limited to the depth capturing device 1201 including the 8 light sources 12011∼12018, that is, in another embodiment of the present invention, the depth capturing device 1201 can include more than two light sources. In addition, as shown in FIG. 11 (b), a field-of-view FOV12020 of the sensor 12020 is equal to 180 degrees, wherein an emitting angle EA1 of the light source 12014 and an emitting angle EA2 of the light source 12018 cannot cover the sensor 12020, that is, infrared light emitted by the light source 12014 and the light source 12018 does not enter directly into the sensor 12020.

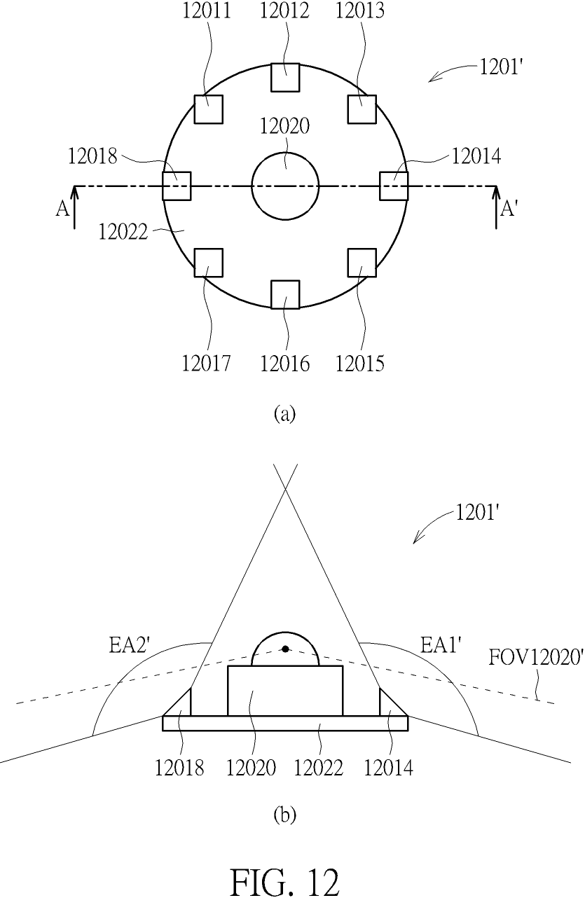

In addition, please refer to FIG. 12. FIG. 12 is a diagram illustrating a depth capturing device 1201′ according to another embodiment of the present invention, wherein the depth capturing device 1201′ is a time of flight device with over 180-degree field-of-view. As shown in FIG. 12 (a), differences between the depth capturing device 1201′ and the depth capturing device 1201 are that light sources 12011∼12018 included in the depth capturing device 1201′ are installed at an edge of the supporter 12022 and a field-of-view FOV12020′ of the sensor 12020 is greater than 180 degrees (as shown in FIG. 12 (b), wherein FIG. 12 (b) is a cross-section view corresponding to an A-A′ cutting line in FIG. 12 (a) ) so that the depth capturing device 1201′ is the time of flight device with over 180-degree field-of-view, wherein an emitting angle EA1′ of the light source 12014 is greater than the emitting angle EA1 and an emitting angle EA2′ of the light source 12018 is greater than the emitting angle EA2, and the emitting angle EA1′ of the light source 12014 and the emitting angle EA2′ of the light source 12018 cannot also cover the sensor 12020. In addition, in another embodiment of the present invention, the emitting angle EA1′ of the light source 12014 is less than the emitting angle EA1 and the emitting angle EA2′ of the light source 12018 is less than the emitting angle EA2, so meanwhile the depth capturing device 1201′ is a time of flight device with less than 180-degree field-of-view.

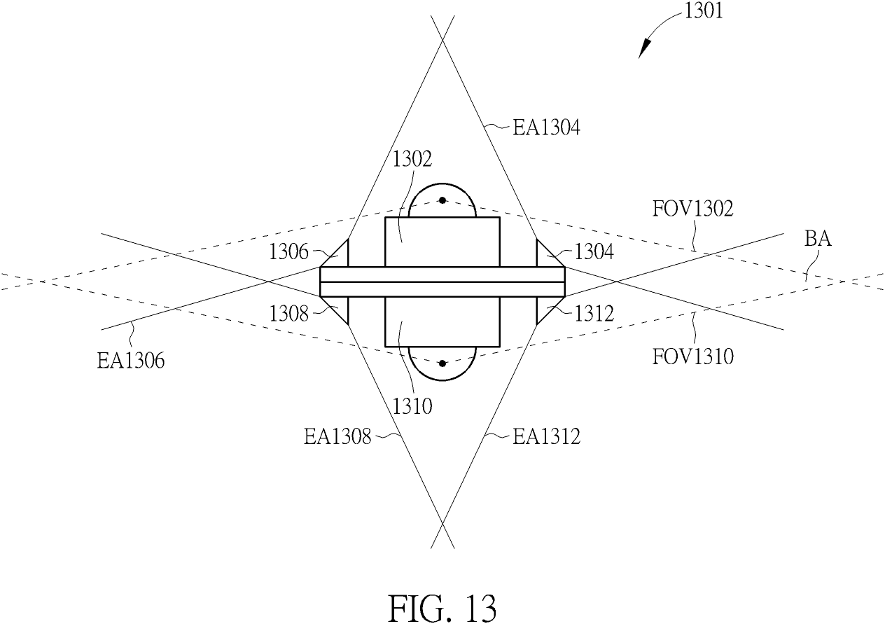

In addition, please refer to FIG. 13. FIG. 13 is a diagram illustrating a cross-section view of a depth capturing device 1301 according to another embodiment of the present invention, wherein the depth capturing device 1301 is a time of flight device with 360-degree field-of-view. As shown in FIG. 13, the depth capturing device 1301 is composed of a first time of flight device and a second time of flight device, wherein the first time of flight device and the second time of flight device are installed beck to back, and the first time of flight device and the second time of flight device are time of flight devices with more than 180-degree field-of-view. As shown in FIG. 13, the first time of flight device at least includes light sources 1304, 1306 and a sensor 1302, and the second time of flight device at least includes light sources 1308, 1312 and a sensor 1310, wherein the light sources 1304, 1306, 1308, 1312 have emitting angles EA1304, EA1306, EA1308, EA1312, respectively, and the sensors 1302, 1310 have field-of-views FOV1302, FOV1310, respectively. However, as shown in FIG. 13, although the depth capturing device 1301 is a time of flight device with 360-degree field-of-view, the depth capturing device 1301 still has a blind zone BA, wherein compared to an environment where the depth capture device 1301 is located, the blind area BA is very small.

In addition, please refer to FIG. 10 again. When all the plurality of depth capturing devices 1201~120N are time of flight devices with 360-degree field-of-view, a modulation frequency or a wavelength of light emitted by a light source included in each depth capturing device are different from modulation frequencies or wavelengths of light emitted by light sources included in other depth capturing devices of the plurality of depth capturing devices 1201∼120N. Thus, when the processor 1002 receives a plurality of depth information generated by the plurality of depth capturing devices 1201∼120N, the plurality of depth information generated by the plurality of depth capturing devices 1201~120N will not interfere with each other.

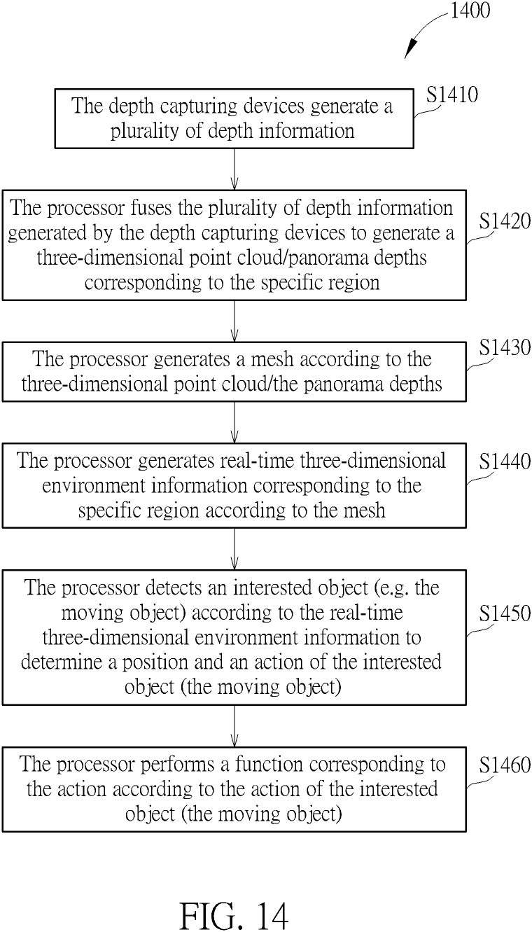

Next, please refer to FIG. 10 and FIG. 14. FIG. 14 is a flowchart illustrating an operational method 1400 of the depth processing system 1000.

The operational method 1400 includes steps S1410 to S1460.

S1410: The depth capturing devices 1201~120N generate a plurality of depth information.

S1420: The processor 1002 fuses the plurality of depth information generated by the depth capturing devices 1201~120N to generate a three-dimensional point cloud/panorama depths corresponding to the specific region CR.

S1430 : The processor 1002 generates a mesh according to the three-dimensional point cloud/the panorama depths.

S1440: The processor 1002 generates real-time three-dimensional environment information corresponding to the specific region CR according to the mesh.

S1450: The processor 1002 detects an interested object (e.g. the moving object 1004) according to the real-time three-dimensional environment information to determine a position and an action of the interested object (the moving object 1004).

S1460: The processor 1002 performs a function corresponding to the action according to the action of the interested object (the moving object 1004).

Steps S1410, S1440 can be referred to descriptions of steps S310, S340, so further description thereof is omitted for simplicity. Differences between steps S1420, S1430 and steps S320, S330 are that the processor 1002 can further generate the panorama depths corresponding to the specific region CR, and further generate the mesh according to the panorama depths. In addition, a difference between step S1450 and step S350 is that the processor 1002 detects the interested object (e.g. moving object 1004) to determine the position and the action of the interested object (the moving object 1004) according to the real-time three-dimensional environment information.

In step S1460, as shown in FIG. 10, because the field-of-view FOV1 of the depth capturing device 1201 and the field-of-view FOV3 of the depth capturing devices 1203 do not cover the moving object 1004, the processor 1002 can generate the notification information NF corresponding to the moving object 1004 to the depth capturing devices 1201, 1203. Therefore, the users corresponding to the depth capturing devices 1201, 1203 can know that the moving object 1004 has been in the specific region CR and may enter the region covered by the field-of-views FOV1, FOV3 of the depth capturing devices 1201, 1203 within the specific region CR through the notification information NF. That is, the users corresponding to the depth capturing devices 1201, 1203 can execute corresponding actions for coming of the moving object 1004 through the notification information NF (e.g. the users corresponding to the depth capturing devices 1201, 1203 can notify people in the specific area CR that the moving object 1004 is going to enter the region covered by the field-of-views FOV1, FOV3 of the depth capturing devices 1201, 1203 within the specific area CR through microphones).

In addition, in some embodiments of the present invention, for making the depth capturing devices 1201~120N be capable of generating the plurality of depth information synchronously so as to fuse the plurality of depth information to generate the three-dimensional point cloud, the operational method 1400 can further include a step for the processor 1002 to perform a synchronization function, wherein the step for the processor 1002 to perform the synchronization function can be referred to FIGS. 8, 9, so descriptions for a structure of the each depth capturing device is omitted for simplicity.

In addition, in some embodiments of the present invention, for making the real-time 3D environment information generated by the depth processing system 1000 widely applied, the operational method 1400 can further store the 3D information generated by the depth processing system 1000 in the binary-voxel format. For example, all the plurality of depth information generated by the plurality of depth capturing devices 1201~120N and the three-dimensional point cloud/the panorama depths corresponding to the specific region CR are stored in the binary-voxel format, wherein that taking the three-dimensional point cloud as an example can be referred to FIG. 7 and corresponding descriptions, so further description thereof is omitted for simplicity.

To sum up, when the moving object enters the specific region from outside of the specific region, the depth processing system of the present invention can generate the notification information corresponding to the moving object to depth capturing devices within the depth processing system whose field-of-views do not cover the moving object, so the users corresponding to the depth capturing devices whose field-of-views do not cover the moving object can execute corresponding actions for coming of the moving object through the notification information. Therefore, the depth processing system of the present invention can increase application scopes of the three-dimensional point cloud/the panorama depths.

Although the present invention has been illustrated and described with reference to the embodiments, it is to be understood that the invention is not to be limited to the disclosed embodiments, but on the contrary, is intended to cover various modifications and equivalent arrangements included within the spirit and scope of the appended claims.

What is claimed is:

1. A depth processing system, comprising:
a plurality of depth capturing devices, wherein each depth capturing device of the plurality of depth capturing devices generates depth information corresponding to a field-of-view thereof according to the field-of-view; and
a processor fusing a plurality of depth information generated by the plurality of depth capturing devices to generate a three-dimensional point cloud/panorama depths corresponding to a specific region, and detecting a moving object within the specific region according to the three-dimensional point cloud/the panorama depths.

2. The depth processing system of claim 1, wherein the processor further generates notification information corresponding to the moving object to at least one depth capturing device of the plurality of depth capturing devices, wherein a field-of-view of the at least one depth capturing device does not cover the moving object.

3. The depth processing system of claim 1, wherein the each depth capturing device is a time of flight (ToF) device, the each depth capturing device comprises a plurality of light sources and a sensor, and the sensor senses reflected light generated by the moving object and generates depth information corresponding to the moving object accordingly, wherein the reflected light corresponds to light emitted by the plurality of light sources.

4. The depth processing system of claim 3, wherein the plurality of light sources are light emitting diodes (LEDs) or laser diodes (LDs), the light emitted by the plurality of light sources is infrared light, and the sensor is an infrared light sensor.

5. The depth processing system of claim 3, wherein the sensor is a fisheye sensor, and a field-of-view of the fisheye sensor is not less than 180 degrees.

6. The depth processing system of claim 3, wherein a frequency or a wavelength of the light emitted by the plurality of light sources is different from a frequency or a wavelength of light emitted by a plurality of light sources comprised in other depth capturing devices of the plurality of depth capturing devices.

7. The depth processing system of claim 1, further comprising:
a structured light source, wherein the structured light source emits structured light toward the specific region, and the each depth capturing device generates the depth information corresponding to the field-of-view thereof according to the field-of-view thereof and the structured light.

8. The depth processing system of claim 7, wherein the structured light source is a laser diode (LD) or a digital light processor (DLP) .

9. The depth processing system of claim 1, wherein the processor further stores the depth information and the three-dimensional point cloud/the panorama depths corresponding to the specific area in a voxel format.

10. The depth processing system of claim 9, wherein:
the processor divides the specific region into a plurality of unit spaces;
each unit space corresponds to a voxel;
when a first unit space has points more than a predetermined number, a first voxel corresponding to the first unit space has a first bit value; and
when a second unit space has points no more than the predetermined number, a second voxel corresponding to the second unit space has a second bit value.

11. An operational method of a depth processing system, the depth processing system comprising a plurality of depth capturing devices and a processor, the operational method comprising:
each depth capturing device of the plurality of depth capturing devices generating depth information corresponding to a field-of-view thereof according to the field-of-view;
the processor fusing a plurality of depth information generated by the plurality of depth capturing devices to generate a three-dimensional point cloud/panorama depths corresponding to a specific region; and
the processor detecting a moving object within the specific region according to the three-dimensional point cloud/the panorama depths.

12. The operational method of claim 11, further comprising:
the processor generating notification information corresponding to the moving object to at least one depth capturing device of the plurality of depth capturing devices, wherein a field-of -view of the at least one depth capturing device does not cover the moving object.

13. The operational method of claim 11, wherein the processor executes a synchronization function to control the plurality of depth capture devices to synchronously generate the plurality of depth information.

14. The operational method of claim 11, wherein when the each depth capturing device is a time of flight (ToF) device, a frequency or a wavelength of light emitted by a plurality of light sources comprised in the each depth capturing device is different from a frequency or a wavelength of light emitted by a plurality of light sources comprised in other depth capturing devices of the plurality of depth capturing devices.

15. The operational method of claim 11, wherein the depth processing system further comprises a structured light source, the structured light source emits structured light toward the specific region, and the each depth capturing device generates the depth information corresponding to the field-of-view thereof according to the field-of -view thereof and the structured light.

16. The operational method of claim 11, wherein the processor detecting the moving object within the specific region according to the three-dimensional point cloud/the panorama depths comprises:
the processor generating a mesh according to the three-dimensional point cloud;
the processor generating real-time three-dimensional environment information corresponding to the specific region according to the mesh; and
the processor detecting the moving object within the specific region according to the real-time three-dimensional environment information.

17. The operational method of claim 11, further comprising:
the processor further storing the depth information and the three-dimensional point cloud/the panorama depths corresponding to the specific area in a voxel format.

18. The operational method of claim 17, further comprising:
the processor dividing the specific region into a plurality of unit spaces;
each unit space corresponding to a voxel;
a first voxel corresponding to a first unit space having a first bit value when the first unit space has points more than a predetermined number; and
a second voxel corresponding to a second unit space having a second bit value when the second unit space has points no more than the predetermined number.
